(19) United States
(12) Patent Application Publication
(10) Pub. No.: US 2022/0141240 A1
(43) Pub. Date: May 5, 2022

(54) COMPUTER-IMPLEMENTED METHOD AND BLOCKCHAIN SYSTEM FOR DETECTING AN ATTACK ON A COMPUTER SYSTEM OR COMPUTER NETWORK

(71) Applicant: Siemens Aktiengesellschaft, München (DE)

(72) Inventor: Tolga Sel, München (DE)

(21) Appl. No.: 17/434,097

(22) PCT Filed: Feb. 28, 2020
(86) PCT No.: PCT/EP2020/055252

§ 371 Date: Aug. 26, 2021

(30) Foreign Application Priority Data
Mar. 1, 2019 (EP) 19160181.4

(51) Int. Cl. H04L 9/40; G06F 21/55

(52) U.S. Cl. CPC H04L 63/1425; G06F 2221/034; G06F 21/552

(57) ABSTRACT

The disclosure relates to a computer-implemented method for detecting an attack on a computer system or computer network. The method includes: inserting an analysis code or module for the computer system or computer network as a smart contract into a blockchain having a plurality of blocks linked to one another; defining parameters for the analysis code; executing the analysis code based on the parameters; and inserting the analysis result into the blockchain. At least a portion of the parameters corresponds to the behavior of the computer system or computer network and includes a log file of the computer system or computer network.

The present patent document is a § 371 nationalization of PCT Application Serial No. PCT/EP2020/055252, filed Feb. 28, 2020, designating the United States, which is hereby incorporated by reference, and this patent document also claims the benefit of European Patent Application No. 19160181.4, filed Mar. 1, 2019, which is also hereby incorporated by reference.

### TECHNICAL FIELD

The disclosure relates to a computer-implemented method and a blockchain system for detecting an attack on a computer system or computer network.

### BACKGROUND

An intrusion detection system (IDS) is a system that actively monitors computer systems or computer networks to detect any attacks. The following two techniques are used for detecting attacks in an IDS.

Signature-based attack detection methods use attack patterns (or “attack signatures”) stored in a database to monitor an active system. Attacks are detected by the IDS comparing attack signatures from its database with the current system behavior. If a stored signature matches the current system behavior, the IDS then concludes that an attack is taking place.

An anomaly-based IDS attempts to detect attacks by detecting changes in the system behavior. Specifically, this means that, in the first act, the IDS learns/analyzes the normal behavior of the computer system, or, in other words, that a trusted third authority learns the normal behavior of the computer system in order to compare the current behavior of the system with the previously learned normal behavior in the second act. If the current behavior differs from the normal behavior learned beforehand, this may then be considered an anomaly that may be a sign of an attack on a computer system. The decision as to whether the system has deviated from its normal behavior may be implemented by statistical methods or machine learning algorithms.

A host-based intrusion detection system (HIDS) is an IDS that is installed on a computer system and collects information about the operating state of the computer system in order to use this information to detect attacks. A network-based intrusion detection system (NIDS) attempts to discover attacks by analyzing network traffic.

In order to implement these two types of IDS (e.g., HIDS, NIDS), a log file or log messages of the current system behavior is first created, which contain(s) the automatically maintained record of all or specific actions of processes on the system. Log messages document the system behavior, such as system calls, data accesses, network packets, communication protocols, user logins, failed calls, active network connections, input values of external sensors and actuators, etc. These log messages (or this log file) are then analyzed and evaluated by an IDS. The result of the log message analysis shows whether an attacker was/is active on the system or not.

However, attackers who have gained control of the relevant computer system or the corresponding IDS may manipulate the analysis of the log messages. In other words, although the log messages already contain information about an attacker, the result of the log message analysis performed by the IDS shows a normal operating state of the system, because the attacker has already taken control of the IDS and falsified this result accordingly.

In order to prevent this, the log message analysis may be performed on a central and trusted authority, which provides a so-called “remote attestation service”. The analysis of the log messages carried out on a secure authority is carried out in a secured environment with increased security measures.

However, one problem with such a central authority is that the entire ecosystem views the authority as a central security node which may lead to a so-called “single point of failure”. This refers to a component of a technical system, the failure of which results in the failure of the entire system.

It may be desirable to analyze past analyses/log messages of a particular component at a later time. This may be the case if a component produces an error and the respective operator would like to examine the previous analysis runs/log messages for any abnormalities. In this case, the monitored system is not only intact or complete at runtime, but the integrity of previous analyses is also provided. This gives rise to a complex and expensive central analysis authority, where there is still a risk of a single point of failure.

Because a central authority may perform the log message analysis for multiple customers, the system provides a very high uptime of the central authority using redundancy mechanisms. This may also cause the central analysis authority to be complex and expensive.

The high costs of the central authority are incurred by the operator, which under certain circumstances may destroy the relevant business by making it economically unattractive.

In addition, in the case of a central authority, such systems may be complex, as multiple customers are served in parallel.

Chinese patent application CN 108 306 893 A discloses a method that comprises a configuration of the blockchain system on a cluster head node in a plurality of networks to form a blockchain network. The cluster head node of the log information is sent to a transaction request of the blockchain system, wherein the transaction request contains a record of the log information by the cluster head node locally according to a transaction format of the blockchain system. The cluster head node is received by the transaction request that is transmitted to the cluster head node. Intrusion attempts are detected using the log information and the blockchain network.

### SUMMARY AND DESCRIPTION

Therefore, the object of the disclosure is to create a computer-implemented method, a system, a computer program, and a computer-readable medium for detecting an attack on a computer system or computer network, which in a simple and economically attractive way increase the level of security with regard to the detection of an attack on a computer system or computer network.

The scope of the present disclosure is defined solely by the appended claims and is not affected to any degree by the statements within this summary. The present embodiments may obviate one or more of the drawbacks or limitations in the related art.

The technology of blockchains or “distributed ledgers” is one that is currently the subject of intensive discussion, as it may be implemented in particular as a distributed database system. In addition to applications for decentralized payment systems (e.g., Bitcoin), new applications are being developed in the financial sector. In particular, it allows transactions between companies to be implemented in a tamper-proof manner without intermediaries or clearing houses. This enables new business models without a trusted intermediary, reduces transaction costs, and provides the flexibility to offer new digital services without having to set up a dedicated infrastructure or trust relationships. For example, a transaction record (or transaction for short) protected by a blockchain includes program code, which may also be referred to as a “smart contract”.

A “smart contract” may be understood in connection with the disclosure, for example, as a piece of executable program code. The smart contract may be stored in a transaction of a distributed database system (e.g., a blockchain), for example, in a data block of the distributed database system. Two simple examples of a smart contract are as follows: if the sum x arrives from the address y, execute z; and if the sum y>2*x arrives from the address z, send 2*x to v.

Smart contracts may be executed by mining nodes. “Mining nodes” are blockchain nodes that execute smart contracts and try to store the result of the execution as a new block in the blockchain. Mining nodes are rewarded for executing smart contracts and are only paid if they manage to insert a new block into the blockchain. To achieve this, the mining nodes solve a cryptographic puzzle, (e.g., a computationally intensive task).

According to a first aspect, the disclosure relates to a computer-implemented method for detecting an attack on a computer system or computer network. The method includes: inserting an analysis code or module for the computer system or computer network as a smart contract into a blockchain having a plurality of concatenated blocks; inserting a machine learning model for the analysis code into the blockchain, wherein the machine learning model or a hash value of the machine learning model is stored in the smart contract; defining parameters for the analysis code, wherein at least a portion of the parameters corresponds to the behavior of the computer system or computer network and includes a log file of the computer system or computer network, wherein the execution result of the smart contract is the analysis result of the log file with the machine learning model; executing the analysis code based on the parameters; and inserting the analysis result into the blockchain.

The previously used central analysis authority is replaced by a decentralized architecture based on blockchain. Thus, log messages or a log file (which may include only a single log message), which was or were generated by an IDS and/or the corresponding computer system and/or the computer network, may be analyzed by a smart contract. The risk that the results of the log message analysis will be manipulated by an attacker is eliminated. The log messages are now analyzed by the mining nodes, and no longer on the field device (with the relevant computer system for which these log messages were generated) itself or in the central analysis authority. This disclosure uses the blockchain concept to make it more difficult for the attacker to manipulate the log messages, because it is impossible for the attacker to know which mining node will or may create the next block for the blockchain, and the attacker cannot control the majority of the mining nodes.

The analysis of the log messages is no longer carried out on the field device by another device with an IDS, which under certain circumstances may be compromised or under threat. The fundamental security assumption in a blockchain-based solution is that an attacker is never able to control the majority of all the nodes (e.g., mining nodes) in a blockchain system and thereby falsify the results of log message analyses.

In a proof-of-work validation-based blockchain, the attacker must control more than 50% of the entire computing capacity, also known as a “51% attack”, in order to be able to store false results in the blockchain.

“Proof-of-work” may be understood in connection with the disclosure, for example, as solving a computationally intensive task, which is solved in particular as a function of the data-block content or the content of a particular transaction. Such a computationally intensive task is also known as a cryptographic puzzle.

In a proof-of-stake validation-based blockchain, the attacker must control more than 50% of the system currency to be able to store false results in the blockchain.

“Proof-of-stake validation” may be understood in connection with the disclosure, for example, as a method by which a blockchain network arrives at a consensus on which node is allowed to generate the next block.

Due to the technical nature of blockchains, it is also impossible for an attacker to know which mining node stores the analysis result of a log file in the blockchain. As a result, the attacker has no chance of manipulating results of the log message analysis.

Furthermore, integrity protection of log messages is guaranteed. Results of log message analyses are stored in the blockchain and cannot be changed retrospectively by attackers, also due to the technical nature of the blockchain. It is clear to all blockchain nodes which IDS devices are trustworthy/intact and which are not.

Using the method in a blockchain also makes it much easier to scale and maintain the system for detecting an attack. Instead of the operator of a central authority, the entire blockchain community is now responsible for the scaling and maintenance.

In addition, with the decentralized architecture, costs are considerably reduced compared to the central authority. This is because neither redundancy mechanisms nor the operation of a central server with a high-performance system nor experts are required to maintain a blockchain system.

In addition, the problem with the single point of failure is solved, for example, with the decentralized data storage.

In an embodiment, the method further includes inserting an activation code or module for the analysis code into the blockchain, which activation code defines at least one precondition for the execution of the analysis code.

In another embodiment, the activation code defines a time interval between two successive executions of the analysis code, and/or, that the activation code defines a data unit for the execution of the analysis code, and/or, that the activation code defines an event outside the blockchain as a trigger for the execution of the analysis code.

In another embodiment, the analysis code is executed by mining nodes of the blockchain or by the analysis code itself.

In another embodiment, the method further includes providing a reward with a specified reward value for the mining nodes of the blockchain for executing the analysis code; and increasing the specified reward value if the number of mining nodes executing the analysis code is less than a specified value.

In another embodiment, the method further includes inserting a model of the machine learning system for the analysis code into the blockchain.

In another embodiment, one of the mining nodes, which solves a computationally intensive task dependent on the analysis result before the other mining nodes, inserts the analysis result obtained by this mining node into the blockchain.

In another embodiment, the other mining nodes verify the correctness of the analysis result obtained.

In another embodiment, the mining node which is the first to solve the computationally intensive task is penalized if, according to the result of the check, the analysis result calculated by this mining node is incorrect.

In another embodiment, the method further includes checking the authenticity and/or completeness of the parameters for the analysis code, in particular the log file.

According to a second aspect, the disclosure relates to a blockchain system for detecting an attack on a computer system or computer network. The system includes: a first insertion module which is configured to insert an analysis code for the computer system or computer network as a smart contract into a blockchain having a plurality of concatenated blocks and to insert a machine learning model for the analysis code into the blockchain, wherein the machine learning model or a hash value of the machine learning model is configured to be stored in the smart contract; a definition module which is configured to define parameters for the analysis code; and an execution module which is configured to execute the analysis code based on the parameters. At least a portion of the parameters corresponds to the behavior of the computer system or computer network and includes a log file of the computer system or computer network, wherein the execution result of the smart contract is the analysis result of the log file with the machine learning model.

In an embodiment of the blockchain system, the blockchain system has a second insertion module, which is configured to insert an activation code for the analysis code into the blockchain. The activation code may be used to define at least one precondition for the execution of the analysis code.

In another embodiment of the blockchain system, a time interval between two successive executions of the analysis code may be defined by the activation code.

In another embodiment of the blockchain system, a data unit for the execution of the analysis code may be defined by the activation code.

In another embodiment of the blockchain system, an event outside the blockchain may be defined by the activation code as a trigger for the execution of the analysis code.

According to a third aspect, the disclosure relates to a computer program including commands which, when the program is executed by a computer, cause the computer to execute the method according to the first aspect.

According to a fourth aspect, the disclosure relates to a computer-readable medium, including commands which when executed by a computer, cause the computer to execute the method according to the first aspect.

### BRIEF DESCRIPTION OF THE DRAWINGS

The present disclosure is described in more detail below with the aid of the exemplary embodiments specified in the schematic drawings.

FIG. 1 depicts a schematically illustrated embodiment of the computer-implemented method for detecting an attack on a computer system or computer network.

FIG. 2 depicts a schematically illustrated embodiment of the blockchain system for detecting an attack on a computer system or computer network.

FIG. 3 depicts a schematically illustrated embodiment of the computer program.

FIG. 4 depicts a schematically illustrated embodiment of the computer-readable medium.

### DETAILED DESCRIPTION

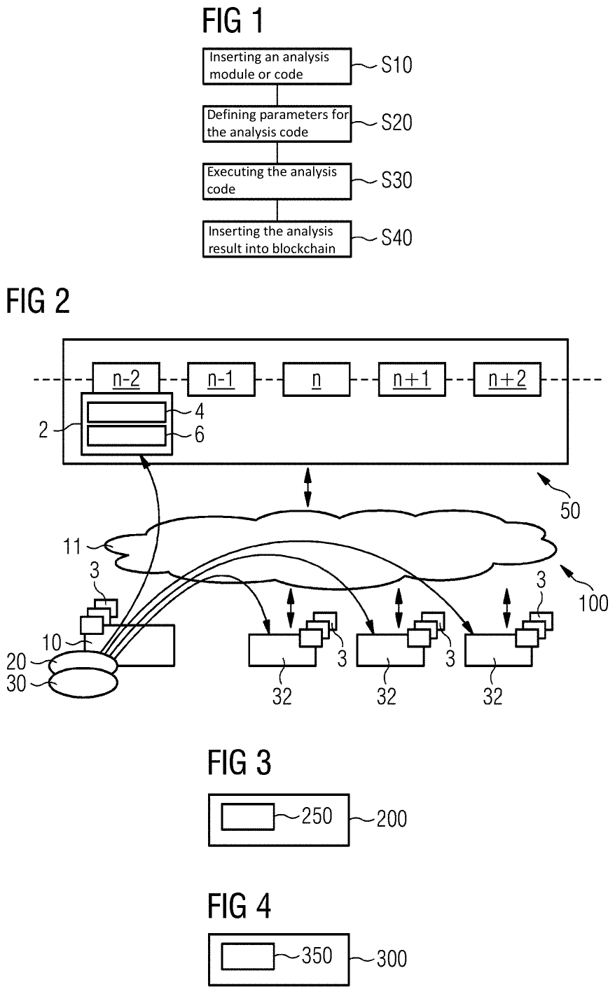

The embodiment of the computer-implemented method for detecting an attack on a computer system or computer network, shown in FIG. 1, includes four acts S10, S20, S30, S40.

In act S10, an analysis code or module for the computer system or computer network is inserted as a smart contract into a blockchain having a plurality of concatenated blocks. In act S20, parameters for the analysis code are defined. At least a portion of the parameters corresponds to the behavior of the computer system or computer network and includes a log file of the computer system or computer network. In act S30, the analysis code is executed based on the parameters. In act S40, the analysis result is inserted into the blockchain.

The embodiment of the blockchain system 100 for detecting an attack on a computer system or computer network, as illustrated in FIG. 2, includes a blockchain 50 with a plurality of concatenated blocks n−2, n−1, n, n+1, n+2. It goes without saying that although only five blocks are shown in FIG. 2, the number of blocks in the blockchain 50 is not limited to five.

This embodiment of the blockchain system 100 also includes a plurality of mining nodes 32, of which three mining nodes 32 are schematically represented in FIG. 2.

An oracle 30 is used in the blockchain system 100 to execute a smart contract 2 correctly. In the context of blockchain, an oracle is a type of agent provided by a third-party provider that serves as a data supply for use in smart contracts in blockchains, because blockchains cannot access data outside their network. An oracle verifies events outside of the blockchain and then makes them available to the smart contracts.

The smart contract 2 may only be executed correctly if the oracle 30 confirms that the log messages 3 are authentic and intact. The oracle 30 may also be used to add the parameters for a smart contract 2, such as log messages 3 and/or other parameters such as a machine learning model 4, the authenticity and integrity of which have already been verified, to the smart contract 2.

In an unillustrated embodiment, a plurality of oracles exist that are operated independently of one another to validate the integrity and/or authenticity of log messages and/or other parameters, such as a machine learning model, and add them to the smart contract. This embodiment avoids a situation where all mining nodes would have to trust a single oracle, which may again represent a single point of failure.

In another unillustrated embodiment, log messages may be continuously streamed to one or more oracles or transmitted as a block (e.g. 1 megabyte of log messages at a time). In this context, “streaming” means that as soon as a single log message appears, it is transmitted to one or more oracles. In this case, a one or more log messages may be secured for integrity and authenticity using a cryptographic method (e.g., with a signature or other asymmetric or symmetric cryptography).

The use of an oracle 30 is carried out via MultiSig contracts, which only allow smart contracts to be executed if multiple blockchain nodes, such as mining nodes 32 and/or oracle/oracles 30, agree to the validity of these smart contracts and thus their execution.

In an unillustrated embodiment, the function of the oracle is performed directly by mining nodes 32. The mining nodes 32 may receive the log messages and validate their integrity or authenticity, send them to the blockchain system and have them analyzed by all mining nodes.

The smart contract 2 may be executed periodically, e.g., every ten minutes. When the time has elapsed, an alarm clock 20 makes the necessary “gas” available to mining nodes 32 at the corresponding “gas price” in order to have the smart contract 2 executed by the blockchain nodes.

An “alarm clock” refers to special blockchain nodes that pay mining nodes 32 to execute specific smart contracts 2. In the context of blockchains, “gas” is a medium that is needed to run computing operations in the blockchain 50. The more computationally intensive a smart contract 2 is, the more gas is required. The “gas price” indicates how much one is willing to pay the mining nodes 32 for a computing operation. The more one is willing to pay, the greater the probability that the smart contract 2 will be executed.

In an embodiment not illustrated in FIG. 2, it is possible to execute the smart contract 2 on its own at a given time. In this embodiment, no alarm clock 20 is required.

The mining nodes 32 that execute this smart contract 2 may use the machine learning model 4 inherent in the smart contract 2 to analyze the log messages 3 generated by a field device 10 in the form of a robot arm, for example. It is also possible for the mining nodes 32 to use other methods, such as a simple conditional instruction and branching (for example, “if-else” in many programming languages with C-like syntax), to analyze the log messages 3.

When the analysis process ends, the mining nodes 32 generate a new block with the result of the log message analysis and attempt to save the result in the blockchain 50. In addition to the result of the log message analysis, other blockchain transactions, (e.g., payments and/or contracts and smart contract results), may be stored in this block. This requires proof-of-work validation, proof-of-stake validation, or another type of validation for block generation.

The mining node 32 which is the first to solve the cryptographic puzzle and generate a new block n−1 publishes the result of the analysis in the blockchain network 11. Only this mining node 32 receives the payment or reward. The remaining mining nodes 32 analyze whether the result is correct and accept the new block n−1.

If the smart contract 2 has not been executed and the mining nodes 32 have other smart contracts, the payment or reward may be increased. Either the alarm clock 20 or the smart contract 2 itself may increase the payment. It is also possible for the alarm clock 20 to add parameters, such as the log messages 3, to the smart contract.

In the smart contract 2, the machine learning model 4 or a hash value of this model 4 is stored. The smart contract 2 is stored in the blockchain 50 and has an activation interval 6, which specifies when the smart contract 2 may be executed (for example, every 10 minutes or once for each log message). The activation interval may be time-based or triggered by events from the outside world. Such an event is an initiator or trigger for the execution of the smart contract 2 and may be such that robot arms have received an order for a new vehicle to be assembled. The integrity/intactness of the corresponding control component is now checked. The log messages of the relevant robot arms are analyzed based on blockchain to find out whether they are still functioning as prescribed or whether they have been manipulated.

The smart contract 2 may also have an activation data unit that specifies how much data the parameters for the smart contract 2 will need in order to execute the smart contract 2.

If the activation interval 6 has expired, the smart contract 2 may be executed. The execution may either be performed by the alarm clock 20, or the smart contract 2 executes itself, e.g., by a time-controlled trigger.

The function of the alarm clock 20 may be carried out by the device 10, the oracle 30, the mining node 32, or another, third authority (not shown in FIG. 2).

The alarm clock 20, or the smart contract 2 itself, defines the reward (e.g., the gas and the gas price) for the mining nodes 32. The alarm clock 20 distributes an order, or an offer, to the peer-to-peer blockchain network 11. Thus, the order is received by the mining nodes 32 that are known to the alarm clock 20 and which may further distribute it to mining nodes that are known to them. In this offer, the alarm clock 20 offers a specific gas price for the execution of the smart contract 2 with the log messages 3. If the gas price is sufficiently lucrative, it is possible that more than two thirds of all mining nodes 32 will accept the order. The result of execution of the smart contract 2 is the analysis result of the log messages 3 with the machine learning model 4.

If the gas price was too low, it may be the case that the smart contract 2 has not been executed or that the number of mining nodes was low and thus the probability of successfully generating a block in the blockchain was also low, and the mining nodes 32 have executed other more lucrative smart contracts. The reward is increased, (e.g., incrementally), until the smart contract 2 is successfully executed and the result is stored in the blockchain 50.

If only the hash value (e.g., integrity test value) of the current machine learning model 4 is represented, this model, (e.g., the machine learning model 4 corresponding to the hash value), may also be considered as an input parameter for the smart contract 2 and distributed.

After the mining nodes 32 have calculated the result of the log message analysis, they attempt to create a valid block n−1 for the blockchain 50. A block is only valid if it solves a specific cryptographic problem. The mining node 32 which is the first to solve this problem is rewarded for its work. The remaining mining nodes 32 check the result of this mining node. If the result has been calculated correctly, then all blockchain nodes accept the new block.

If the analysis is incorrect after the result of the check, then the corresponding mining node may be penalized, for example, by imposing a penalty payment. Alternatively, this mining node may be completely banished from the blockchain network 11.

In a proof-of-stake detection-based blockchain, communication nodes in the system 100, (e.g., mining nodes 32), deposit a form of security bond in order to participate in the protocol and thus in the consensus procedure. If a mining node 32 returns an incorrect result, part of its deposit will be taken away. As a result, attacks will become economically unattractive. This creates a motivation for the mining nodes 32 to behave “honestly” in the system 100 and to deliver correct results.

In a proof-of-work validation-based blockchain, the attacker must control more than 50% of the entire computing power in the system to be able to store a successful attack (e.g., false IDS analysis results) in the blockchain 50.

The embodiment of the computer program 200 as described in FIG. 3 includes commands 250, which when the program 200 is executed by a computer, cause it to execute the method according to FIG. 1.

The embodiment of the computer-readable medium 300 as described in FIG. 4 includes commands 350, which when executed by a computer, cause it to execute the method according to FIG. 1.

Although the present disclosure has been fully described above on the basis of exemplary embodiments, it is in fact not limited thereto, but may be modified in a wide variety of ways. For example, it is not necessary for the oracle to initialize the blockchain. Another blockchain node (e.g., a company or an authority) may also load a smart contract into the blockchain for log message analysis for its own control modules.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A computer-implemented method for detecting an attack on a computer system or computer network, the method comprising:
inserting an analysis code for the computer system or computer network as a smart contract into a blockchain having a plurality of concatenated blocks;
inserting a machine learning model for the analysis code into the blockchain, wherein the machine learning model or a hash value of the machine learning model is stored in the smart contract;
defining parameters for the analysis code, wherein at least a portion of the parameters corresponds to a behavior of the computer system or computer network and comprises a log file of the computer system or the computer network;
executing the analysis code based on the parameters; and
inserting an analysis result into the blockchain,
wherein an execution result of the smart contract is the analysis result of the log file with the machine learning model.

2. The method of claim 1, further comprising:
inserting an activation code for the analysis code into the blockchain, wherein the activation code defines at least one precondition for the execution of the analysis code.

3. The method of claim 2, wherein the activation code defines a time interval between two successive executions of the analysis code, and/or
wherein the activation code defines a data unit for the execution of the analysis code, and/or
wherein the activation code defines an event outside the blockchain as a trigger for the execution of the analysis code.

4. The method of claim 1, wherein the execution of the analysis code is performed by mining nodes of the blockchain or by the analysis code itself.

5. The method of claim 4, further comprising:
providing a reward with a specified reward value for the mining nodes of the blockchain to execute the analysis code; and
increasing the specified reward value when a number of mining nodes for executing the analysis code is less than a specified value.

6. (canceled)

7. The method of claim 1, wherein a mining node of the mining nodes, which solves a computationally intensive task dependent on the analysis result before the other mining nodes, inserts the analysis result obtained by the mining node into the blockchain.

8. The method of claim 7, wherein the other mining nodes of the mining nodes check the correctness of the analysis result obtained.

9. The method of claim 8, wherein the mining node first to solve the computationally intensive task is penalized when, according to the result of the check performed by the other mining nodes, the analysis result obtained by the mining node is incorrect.

10. The method of claim 1, further comprising:
checking an authenticity and/or completeness of the parameters for the analysis code.

11. A blockchain system for detecting an attack on a computer system or computer network, the system comprising:
a first analysis module configured to insert an analysis code for the computer system or computer network as a smart contract into a blockchain having a plurality of concatenated blocks and configured to insert a machine learning model for the analysis code into the blockchain, wherein the machine learning model or a hash value of the machine learning model is configured to be stored in the smart contract;
a definition module configured to define parameters for the analysis code; and
an execution module configured to execute the analysis code based on the parameters,
wherein at least a portion of the parameters corresponds to a behavior of the computer system or computer network and comprises a log file of the computer system or computer network, and
wherein the execution result of the smart contract is the analysis result of the log file with the machine learning model.

12. The blockchain system of claim 11, further comprising:
a second analysis module configured to insert an activation code for the analysis code into the blockchain,
wherein the activation code is configured to define at least one precondition for the execution of the analysis code.

13. The blockchain system of claim 12, wherein the activation code is configured to define a time interval between two successive executions of the analysis code, and/or
wherein the activation code is configured to define a data unit for the execution of the analysis code, and/or
wherein the activation code is configured to define an event outside the blockchain as a trigger for the execution of the analysis code.

14. A computer program comprising commands which during the execution of the program by a computer, cause the computer to:
insert an analysis code for a computer system or computer network as a smart contract into a blockchain having a plurality of concatenated blocks;
insert a machine learning model for the analysis code into the blockchain, wherein the machine learning model or a hash value of the machine learning model is stored in the smart contract;
define parameters for the analysis code, wherein at least a portion of the parameters corresponds to a behavior of the computer system or computer network and comprises a log file of the computer system or the computer network;
execute the analysis code based on the parameters; and
inserting an analysis result of the executed analysis code into the blockchain,
wherein an execution result of the smart contract is the analysis result of the log file with the machine learning model.

15. (canceled)

16. The method of claim 10, wherein the checking of the authenticity and/or completeness of the parameters for the analysis code comprises checking the log file.
